(19) United States
(12) Patent Application Publication
(10) Pub. No.: US 2009/0115685 A1
(43) Pub. Date: May 7, 2009

(54) Dual band helical antenna with wide bandwidth

(76) Inventors: Shyh-Jong Chung, Hsinchu City (TW); Yu-Hsin Wang, Taichung City (TW); Yu-Chiang Cheng, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/155,022

(22) Filed: May 29, 2008

(30) Foreign Application Priority Data
Nov. 5, 2007 (TW) 96141720

(51) Int. Cl. H01Q 1/36

(52) U.S. Cl. 343/895

(57) ABSTRACT

A dual band helical antenna with wide bandwidth includes a straight section and a helical tail section having a first and a second coil length, respectively. The straight section has a signal feed point located at a lower end thereof being connected to a signal source for feeding in an antenna signal. The first coil length determines a high-frequency resonant frequency of the dual band helical antenna, and a total length of the first and the second coil length determines a low-frequency resonant frequency of the dual band helical antenna. The straight section includes a diametrically expanded section to increase a high-frequency bandwidth of the dual band helical antenna.

### FIELD OF THE INVENTION

The present invention relates to a dual band helical antenna, and more particularly to a dual band helical antenna with increased high-frequency bandwidth.

### BACKGROUND OF THE INVENTION

In the conventional antenna techniques, a helical antenna is frequently used as a signal transmitting and receiving device. Compared to the general cylindrical antenna, the helical antenna has the advantage of having an antenna length shorter than that of a monopole antenna, and is therefore widely adopted among users. According to the currently available techniques for helical antenna, it is not necessarily to provide on a helical antenna with fixed coil pitch angle, coil diameter, and number and spacing of coil turns. Therefore, two or more sections having different lengths may be provided on the helical antenna for use with different resonant frequencies, so as to achieve the function of dual-frequency or multi-frequency for application in the GSM 900/1800 MHZ system commonly used on general cell phones, for example.

For instance, Taiwan Patent Publication No. 506631 discloses a structure of helix antenna comprising a non-uniform helical coil compressively positioned between an inner insulating sleeve and an external insulating sleeve slipping one over the other. The coil has upper and lower ends respectively abutted against the inner top surface of the external insulating sleeve and a metallic connecting seat of the inner insulating sleeve. A metallic contact piece has an end abutted against the metallic connecting seat, and a continuous bending portion at another end exposed from a side slit on the inner insulating sleeve to form a bottom end for press contacting an RF electric circuit of a communication instrument. The coil has on the upper end a diametrically extending bent section to be an added loading of the antenna. The lower end of the coil has a denser coil section positioned on the surface of the metallic connecting seat. The inner and external insulating sleeves respectively have an external protruding annulus and an inner annular recess that are engaged with one another, so that the helical coil positioned between the two insulating sleeves may have a fixed length.

FIG. 1 is a side view of a first conventional dual band helical antenna 100, which includes a signal feed point 10, a first antenna section 11, and a second antenna section 12. The signal feed point 10 is located at a lower end of the first antenna section 11, and is connected to a signal source for feeding in an antenna signal. The first antenna section 11 has a first length L1, which determines a high-frequency resonant frequency of the dual band helical antenna 100. The second antenna section 12 is integrally connected to an upper end of the first antenna section 11 to have a second length L2, and is an antenna section having relatively densely arranged coils. An overall length of the first and the second length L1, L2 determines a low-frequency resonant frequency of the dual band helical antenna 100. The first conventional dual band helical antenna has the advantages of having a relatively small antenna volume to occupy only a reduced space, but it has relatively narrow high and low frequency bandwidths.

FIG. 2 is a side view of a second conventional dual band helical antenna 200, which is structurally similar to the first conventional dual band helical antenna 100, and includes a signal feed point 20, a first antenna section 21, and a second antenna 22. The signal feed point 20 is located at a lower end of the first antenna section 21, and is connected to a signal source for feeding in an antenna signal. For the dual band helical antenna 200 to have wide bandwidth, the first antenna section 21 is a straight section instead of a helical section as that in the first conventional dual band helical antenna 100, and has an extended first length L3 to thereby enable a relatively large high-frequency bandwidth. The second antenna section 22 is integrally connected to an upper end of the first antenna section 21 and has a second length L4. A total length of the first and the second length L3, L4 determines a low-frequency resonant frequency of the dual band helical antenna 200.

As having been mentioned above, the first conventional dual band helical antenna 100 of FIG. 1 is advantageous in a relatively small volume to occupy a reduced space but has relatively narrow high and low frequency bandwidths. And, the second conventional dual band helical antenna 200 as an modification of the first conventional conventional dual band helical antenna 100 has a straight and extended first antenna section 21 that is of benefit to the radiation of high and low frequencies. However, there is still space for improving the second conventional dual band helical antenna 200.

### SUMMARY OF THE INVENTION

A primary object of the present invention is to provide a dual band helical antenna, which includes a first antenna section having an expanded diameter larger than that for the conventional dual band helical antennas and therefore has an increased high frequency bandwidth.

To fulfil the above object, the present invention provides a dual band helical antenna with wide bandwidth, which includes a straight section and a helical tail section having a first and a second coil length, respectively. The straight section has a signal feed point located at a lower end thereof being connected to a signal source for feeding in an antenna signal. The first coil length determines a high-frequency resonant frequency of the dual band helical antenna, and a total length of the first and the second coil length determines a low-frequency resonant frequency of the dual band helical antenna.

The dual band helical antenna according to the present invention includes a diametrically expanded antenna section having an expanded diameter and therefore has largely increased high frequency bandwidth, compared to the conventional dual band helical antennas, allowing the dual band helical antenna to be applied in more different bandwidths. In addition to a substantially zero-spacing dense coil, the diametrically expanded antenna section may be otherwise manufactured using a metal braided net or an elastic flexible metal tube, so as to overcome the difficulties in manufacturing the highly dense coil and to lower the labor and manufacturing costs for the dual band helical antenna.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a side view of a first conventional dual band helical antenna;

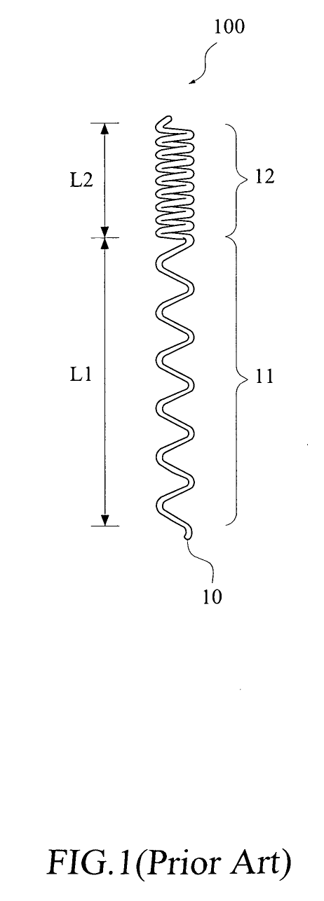

FIG. 2 a side view of a second conventional dual band helical antenna;

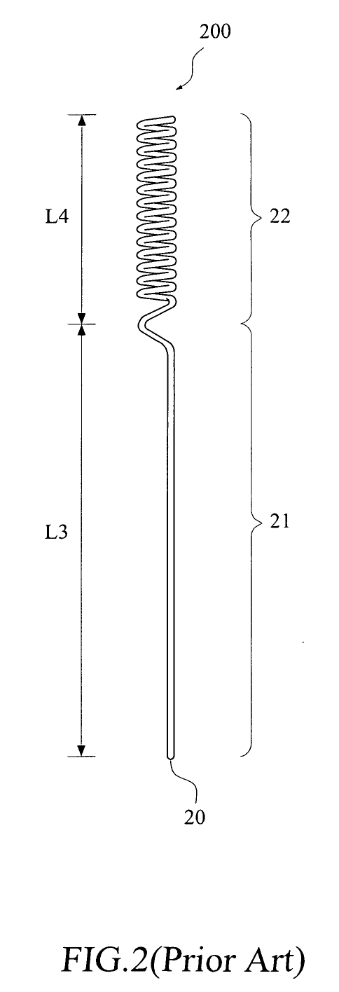

FIG. 3 is a side view of a dual band helical antenna with wide bandwidth according to a first embodiment of the present invention;

FIG. 4 is a side view of a dual band helical antenna with wide bandwidth according to a second embodiment of the present invention; and

FIG. 5 is a side view of a dual band helical antenna with wide bandwidth according to a third embodiment of the present invention.

### DETAILED DESCRIPTION OF THE PREFERRED EMBODIMENTS

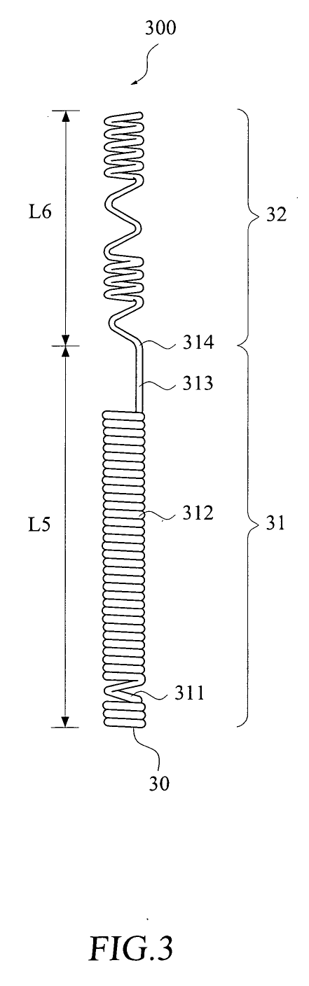

Please refer to FIG. 3 that is a side view of a dual band helical antenna 300 according to a first embodiment of the present invention. As shown, the dual band helical antenna 300 includes a signal feed point 30, a straight section 31, and a helical tail section 32. The signal feed point 30 is located at a lower end of the straight section 31 and is connected to a signal source for feeding in an antenna signal. The straight section 31 includes an impedance matching section 311, a diametrically expanded section 312, a transit section 313, and a junction 314, and has a first coil length L5, which determines a high-frequency resonant frequency of the dual band helical antenna 300. The impedance matching section 311 includes a length of relatively sparse coil. However, the sparseness of the coil of the impedance matching section 311 may be adjusted to change an equivalent inductance value of the impedance matching section 311, so as to achieve impedance matching for the dual band helical antenna 300.

The diametrically expanded section 312 has a substantially zero-spacing dense coil structure and has an expanded diameter. According to the established antenna theory, this diametrically expanded and dense coil section 312 may increase the high-frequency bandwidth of the dual band helical antenna 300. The transit section 313 serves as a transit between the straight section 31 and the helical tail section 32 to separate the straight section 31 from the helical tail section 32, so that electric current does not flow from the straight section 31 to the helical tail section 32 in a fully continuous manner.

The helical tail section 32 is connected to the junction 314 at an upper end of the straight section 31, and has a second coil length L6. A total length of the first and the second coil length L5, L6 determines a low-frequency resonant frequency of the dual band helical antenna 300. Therefore, it is possible to adjust the second coil length L6 for the resonance to occur at the helical tail section 32 of the dual band helical antenna 300. More particularly, the helical tail section 32 may be adjusted by changing the density of coil turns therein to thereby reduce the influence of the helical tail section 32 on the high-frequency resonance, so that the high-frequency resonance is controlled as much as possible by the diametrically expanded section 312 of the straight section 31.

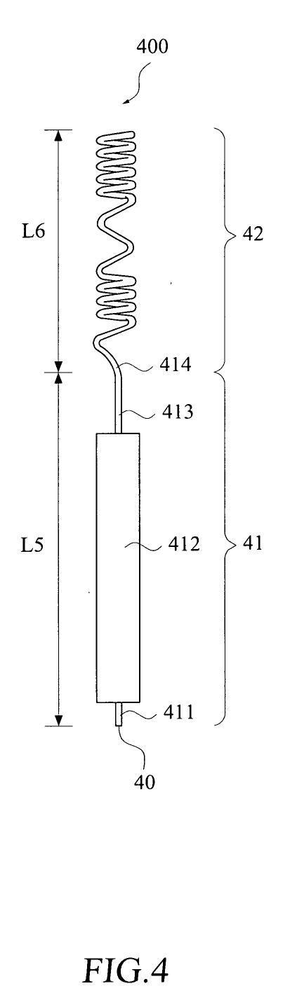

Please refer to FIG. 4 that is a side view of a dual band helical antenna 400 according to a second embodiment of the present invention. As shown, the dual band helical antenna 400 includes a signal feed point 40, a straight section 41, and a helical tail section 42. The straight section 41 and the helical tail section 42 have a first coil length L5 and a second coil length L6, respectively. The straight section 41 includes an impedance matching section 411, a diametrically expanded section 412, and a transit section 413. Since the second embodiment is generally structurally similar to the first embodiment, it is not described in details herein. The second embodiment is different from the first embodiment mainly in that the diametrically expanded section 412 of the straight section 41 consists of a thick metal tube having a relatively large diameter. As the substantially zero-spacing dense coil structure adopted in the first embodiment, the thick metal tube with a large diameter is able to increase the high-frequency bandwidth of the dual band helical antenna 400.

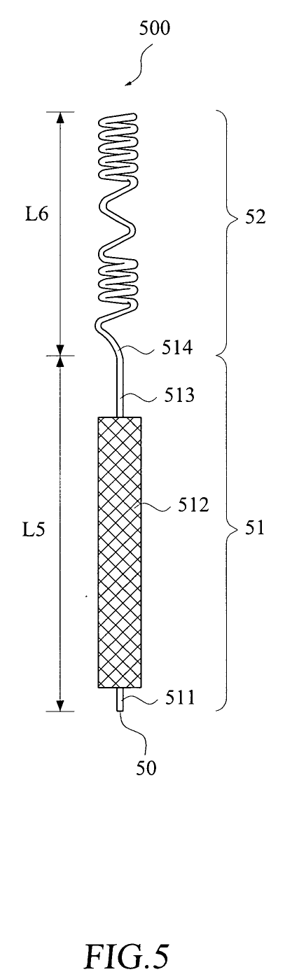

FIG. 5 is a side view of a dual band helical antenna 500 according to a third embodiment of the present invention. As shown, the dual band helical antenna 500 includes a signal feed point 50, a straight section 51, and a helical tail section 52. The straight section 51 and the helical tail section 52 have a first coil length L5 and a second coil length L6, respectively. The straight section 51 includes an impedance matching section 511, a diametrically expanded section 512, and a transit section 513. Since the third embodiment is generally structurally similar to the previous embodiments, it is not described in details herein. The third embodiment is different from the previous embodiments mainly in that, for the straight section 51 to be flexible, the diametrically expanded section 512 of the straight section 51 is made of a braided metal net to provide sufficient flexibility. The diametrically expanded section 512 formed from a braided metal net also has an expanded diameter to increase the high-frequency bandwidth of the dual band helical antenna 500. It is understood by those skilled in the art the diametrically expanded section 512 of the straight section 51 may also be formed of other suitable material, such as an elastic flexible metal tube, to provide the flexibility thereof.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A dual band helical antenna, comprising:
a straight section having a first coil length, which determines a high-frequency resonant frequency of the dual band helical antenna, the straight section including a diametrically expanded section for increasing a high-frequency bandwidth of the dual band helical antenna, a signal feed point located at a lower end of the straight section being connected to a signal source for feeding in an antenna signal, and a junction located at an upper end of the straight section; and
a helical tail section connected to the junction at the upper end of the straight section and having a second coil length, wherein a total length of the first coil length and the second coil length determines a low-frequency resonant frequency of the dual band helical antenna.

2. The dual band helical antenna as claimed in claim 1, wherein the straight section further includes a transit section located at the upper end thereof to serve as a transit between the straight section and the helical tail section to separate the two sections from each other, so that electric current does not flow through from the straight section to the helical tail section in a fully continuous manner.

3. The dual band helical antenna as claimed in claim 1, wherein the straight section further includes an impedance matching section located at the lower end thereof; the impedance matching section including a length of sparse coil; whereby by adjusting a sparseness of the sparse coil in the impedance matching section, an equivalent inductance value of the impedance matching section may be changed to achieve impedance match for the dual band helical antenna.

4. The dual band helical antenna as claimed in claim 1, wherein the diametrically expanded section of the straight section consists of a substantially zero-spacing dense coil.

5. The dual band helical antenna as claimed in claim 1, wherein the diametrically expanded section of the straight section consists of a thick metal tube.

6. The dual band helical antenna as claimed in claim 1, wherein the diametrically expanded section of the straight section consists of a braided metal net.

7. The dual band helical antenna as claimed in claim 1, wherein the diametrically expanded section of the straight section consists of a flexible metal tube.
